(19) United States
(12) Patent Application Publication
(10) Pub. No.: US 2004/0090047 A1
(43) Pub. Date: May 13, 2004

(54) Transportable golf bag with retractable handle

(76) Inventors: Sung Hee Kang, Chesterfield, MO (US); Kristine Kang, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/292,111

(22) Filed: Nov. 12, 2002

(51) Int. Cl. B62B 1/00

(52) U.S. Cl. 280/652

(57) ABSTRACT

A transportable golf bag includes a bottom and walls defining a chamber sized to receive golf clubs. Wheels are mounted to the bottom of the bag to enable the bag to be rolled over a surface. The bag bottom includes a forward portion and a sloped rear portion. The wheels are sized such that when the bag is resting on the forward portion, the wheels are raised above the ground. The golf bag also includes a button-operated extendable/retractable handle. The handle assembly includes a locking assembly within the handle assembly that it operable by a button at the top of the handle. Pressing of the button releases the locking assembly to allow for the handle, when extended, to be retracted.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This version of the invention is concerned with the field of golf bags. More specifically, this version of the invention is concerned with transportable golf bags that are fabricated with at least two rotating wheels and a retractable handle that telescopes from a retracted, stowed position to an extended position.

In the game of golf, a variety of golf bags are used to store and transport golf clubs, golf balls, and other equipment and accessories to various playing locations on a golf course. Golf bags are generally designed and constructed to be carried or wheeled by a golfer or caddy over the ground or playing surface. Golf bags that are carried are fabricated of one or more storage pouches and compartments and with at least one carrying strap attached thereto. Carrying is accomplished by slinging the golf bag over the shoulder with the strap or belt making direct contact with the top of the shoulder with the full weight of the golf bag and its contents impinging upon the shoulder. Golf bags that are wheeled are constructed with the aforementioned storage pouches and compartments along with at least one pair of rotating wheels attached to the lower portion of the pouch or pouches and a grasping handle affixed to the upper portion thereof.

When wheeled golf bags are stowed, the grasping or pulling handles are retracted, pivoted, or otherwise collapsed in order to occupy a minimal amount of space. Conversely when wheeled golf bags are being used, the handles are extended or reconfigured so that they project for some distance from the pouch or pouches, thereby allowing such bags to be pulled and directed by the golfer or caddy. In some designs, the rotating wheels fold up into the body of the main pouch.

While the grasping or pulling handles and rotating wheels generally improve the ability of a golfer or caddy to transport fully-loaded golf bags over the distances necessary to play a game of golf, many handles suffer from various drawbacks and disadvantages. Some are not properly aligned when extended to provide the most efficient means to pull the golf bags; do not function as a secure, stable means to grasp and direct the golf bags; or are difficult to extend and retract, frequently interfering with the exchange of golf clubs into and out of pouch or pouches of the golf bags. In some designs, elaborate mechanisms are used to deploy and retract the rotating wheels and to stabilize the golf bags when the bags are situated in a stationary position.

What is needed then to overcome the aforementioned disadvantages of wheeled golf bags is the provision of a wheeled or transportable golf bag with retractable handle that is comprised of a pair of rotating wheels permanently attached to the lower portion of said bag; handle that is retracted or extended as necessary in order to occupy minimal space during storage and to provide a secure, unobtrusive means by which the golf bag can be pulled and directed during use; and a support stand that assists in stabilizing the golf bag when said bag is situated in a stationary, generally upright position. The golf bag that is the subject of this invention can be transported by a variety of means, such as being carried by a player or caddy, or transported by various vehicles, including automobiles and driving golf carts.

Numerous designs for transportable or wheeled golf bags have been provided in the prior art. Even though these designs may be suitable for the specific individual purposes to which they address, they would not be suitable for the purposes of the present version of the invention. Such designs are exemplified by U.S. Pat. No. 4,400,006, Golf Bag Provided With A Retractable Rolling Assembly, issued to Larkin on 23 Aug. 1983; U.S. Pat. No. 5,470,095, Transportable Golf Bag, issued to Bridges on 28 Nov. 1995; U.S. Pat. No. 6,056,301, Golf Bag Having Retractable Wheels and Handle, issued to Berliner et al. on 2 May 2000; and U.S. Pat. No. 6,139,047, Golf Bag Equipped With Detachable Carrier, issued to Kim on 31 Oct. 2000.

As such, it may be appreciated that there is a continuing need for a new and improved transportable golf bag fabricated with a telescoping handle that provides a stable means by which to grasp, pull, and direct the golf bag; pair of rotating wheels attached to the lower portion of said golf bag; and support stand that is releasably attached thereto in order to stabilize the golf bag at various locations upon a golf course. In these respects, the present version of the invention substantially departs from the conventional concepts and designs of the prior art, and in so doing provides an apparatus that substantially fulfills this need. Additionally, the prior patents and commercial techniques do not suggest the present inventive combination of component elements arranged and configured as disclosed herein.

The present invention achieves its intended purposes, objects, and advantages through a new, useful and unobvious combination of method steps and component elements, with the use of a minimum number of functioning parts, at a reasonable cost to manufacture, and by employing only readily available materials.

### BRIEF SUMMARY OF THE INVENTION

The present version of the invention, which will be described in greater detail hereinafter, relates to the field of golf bags. More specifically, this version of the invention is concerned with transportable golf bags that are fabricated with at least two rotating wheels and a retractable handle that telescopes from a retracted, stowed position to an extended position. Our version of the invention overcomes all of the shortcomings listed previously, in addition to novel aspects that will be described in detail hereinafter.

Described briefly, according to a typical embodiment, the invention presents a transportable golf bag with retractable handle that is constructed to store golf clubs and accessories and to be pulled by said handle in an extended position over the ground surface of a golf course. During non-use, the handle is retracted within its frame so as to present a low profile and compact appearance. The transportable golf bag is generally comprised of a container portion and a handle frame assembly. The container portion includes a main pouch that is fabricated of a continuous side wall configured into a rounded or circular shape when viewed from overhead, closed bottom end, and an opened top end through which golf clubs are inserted and removed from the interior of said pouch. Two side pouches are attached to the exterior of the side wall of the main pouch. A lid cover is releasably attached to the top of the main pouch by a zipper and locking mechanism.

A pair of wheels is affixed to the rear of the container (main pouch) by means of an axle and series of fasteners. The wheels are positioned as such in order to allow the container portion to be supported by said wheels above the ground surface when the golf bag is tilted backward upon the wheels.

The handle frame assembly is attached to the rear side of the main pouch and includes a fixed portion and a retractable or extendable portion. Two rectangular bars and a series of threaded fasteners attach the fixed portion of the handle frame assembly to the main pouch. As such, the retractable portion can be extended above or retracted to the level of the top edge of the main pouch. The fixed portion of the handle frame assembly is further comprised of a horizontal member and two vertical members, which are joined to opposing ends of the horizontal member. Similarly, the retractable portion of the handle comprises of two vertical members, which are received within the vertical members of the fixed portion, and a horizontal member. This horizontal member, which serves as a hand grip for the handle frame assembly, is fabricated with a button that controls the operation of a handle release and lock apparatus situated within the handle frame assembly. When the button is pushed downward, the release and lock apparatus disengages locking buttons that otherwise extend through apertures within the fixed portion of the handle frame assembly, thereby allowing the retractable portion of the handle frame to be pulled upward or extended for use or pushed downward or retracted for non-use or storage.

If necessary, an optional support, stand can be releasably attached to the rear side of the main pouch to -assist in stabilizing the golf bag in an upright position upon the ground surface of a golf course, and two shoulder straps can be releasably attached to the handle frame assembly for carrying the golf bag over stair steps. Transporting the golf bag can be accomplished by grasping the handle and pulling upon the wheels as referenced previously; retracting the handle and carrying by the straps; or placing into the cargo area of a driving golf cart.

Our invention, therefore, resides not in any one of these features per se, but rather in the particular combination of all of them herein disclosed. It is distinguished from the prior art in this particular combination of all of its structures for the functions specified.

In order that the detailed description of the invention may be better understood and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

Accordingly, it is an object of our version of the invention to provide a low-cost, easy-to-manufacture, and easy-to-market transportable golf bag with retractable handle.

A further object of our version of the invention is to provide an easy-to-use and versatile transportable golf bag with retractable handle.

A significant object of the invention is to provide a transportable golf bag with retractable handle that is comprised of a container portion having a main pouch with detachable cover and side pouches; rotating wheels affixed to the rear lower corner of the main pouch by means of an axle and fasteners; handle frame assembly comprised of a fixed portion directly attached to the rear side of the main pouch, a retractable or extendable portion that is telescopingly engaged to the fixed portion, and release and lock apparatus; shoulder carrying straps releasably attached to the handle frame assembly; and a support stand that stabilizes or supports the golf bag in an upright position upon various surfaces of a golf course.

A final but very significant object of the invention is to provide a transportable golf bag with retractable handle, which, upon extension, provides a firm, secure gripping apparatus by which the golf bag can be pulled and directed, and, upon retraction, presents a compact, low-profile so as to occupy minimal space during non-use and storage. During play, the golf bag can be transported by grasping and pulling upon the wheels; retracting the handle and carrying by the straps; or placing into the cargo area of a vehicle, such as a driving golf cart. During non-use the golf cart can be stored and transported within the trunk or cargo area of a vehicle.

For a better understanding of the invention, its operating advantages and the specific objects attained by its uses, reference should be made to the accompanying drawings and descriptive matter in which there are illustrated preferred embodiments of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiments in addition to the scope of the invention illustrated by the accompanying drawings.

### BRIEF DESCRIPTION OF THE SEVERAL VIEWS OF THE DRAWINGS

The foregoing and other objects, features and advantages of the invention will become more fully understood from the following description of the preferred embodiments of the invention as illustrated in the accompanying drawings in which like reference characters refer to the same parts throughout different views. The drawings are not necessarily to scale, emphasis instead being placed upon illustrating the principles of the invention.

FIG. 1 is a perspective view of a transportable golf bag with retractable handle with said handle in the extended position in accordance with the present version of the invention.

FIG. 2 is a perspective view of a transportable golf bag with retractable handle with said handle in the retracted position and a shoulder carrying strap releasably attached to the handle frame assembly in accordance with the present version of the invention.

FIG. 3 is a perspective view of a locking apparatus used to secure a top cover to the main pouch thereof.

FIG. 4 is an elevation view, of the retractable handle of a transportable golf bag with retractable handle displaying the components thereof.

FIG. 5 is a partial cross section of a release and locking apparatus illustrated in exploded view and revealing the individual components thereof.

FIG. 6 is a partial cross section of a locking and release apparatus illustrated as assembled and disposed in the locked position within the handle frame of said golf bag.

FIG. 7 is a partial cross section of a locking and release apparatus illustrated as assembled and disposed in the released configuration in- order, to permit retraction or collapsing of the handle frame of said golf bag.

FIG. 8 is a perspective view of a transportable golf bag with retractable handle with a pivoting support stand releasably attached thereto.

FIG. 9 is a perspective view of a second embodiment of a transportable golf bag with a pivoting handle attached thereto.

FIG. 10 is a perspective view of the second embodiment of a transportable golf bag with a pivoting handle attached thereto, said pivoting handle displayed in a raised position.

FIG. 11 is a perspective view of a third embodiment of a transportable golf bag with a pivoting, extensible handle attached thereto.

FIG. 12 is a perspective view of the third embodiment of a transportable golf bag with a pivoting, extensible handle attached thereto, said pivoting handle displayed in a raised position and extended configuration.

Corresponding reference numerals will be used throughout the several figures of the drawings.

### DRAWING REFERENCE NUMERALS

10 Transportable Golf Bag With Retractable Handle

12 Container

14 Handle Frame

16 Main Pouch

18 Bar

20 Fastener

22 Clasp

24 Lower Side Pouch

26 Upper Side Pouch

28 Top

30 Body

32 Zipper

34 Top

36 Body

38 Upper Portion of Main Pouch

40 Lower Portion of Main Pouch

42 Lip

44 Zipper

46a Zipper Head With Clasp

46b Clasp

48 Aperture

50 Top

52 Wheel

54 Axle

56 Fastener

58 Retractable Portion of Handle Frame

60 Fixed Portion of Handle Frame

62 Hand Grip of Retractable Portion

64 Vertical Member of Retractable Portion

66 Button

68 Vertical Member of Fixed Portion

70 Horizontal Member of Fixed Portion

72 Protuberance

74 Button

76 Strap

78 Lock

80 Upper Member of Hand Grip

82 Lower Member of Hand Grip

84 Fastener

86 Rod

88 Fastener

90 Spring

92 Spring Seat

94 Hanger

96 Rod

98 Knob

100 Middle Member

102 Side Member

104 Side Member

106 Upper Bore

108 Middle Bore

110 Lower Bore

112 Spring

114 Upper Projection

116 Middle Projection

118 Middle Projection

120 Lower Projection

122 Spring

124 Upper Bore

126 Middle Bore

128 Lower Bore

130 Pin

132 Aperture

134 Support Stand

136 Fastener

138 Foot

140 Transportable Golf Bag, Second Embodiment

142 Handle

144 Hand Grip

146 Arm Member

148 Connecting Member

150 Protrusion

152 Transportable Golf Bag, Third Embodiment

154 Handle

156 Hand Grip

158 Arm

160 Connecting Member

162 Panel Member

164 Protrusion

166 Flange

168 Slot

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

Referring now to the drawings and, in particular, to FIG. 1 wherein there is illustrated a typical embodiment of 5 the transportable golf bag with retractable and extendable handle 10 with the handle in the fully raised or extended configuration. The present version of the invention 10 is comprised of a container portion 12 and handle frame assembly 14, said handle frame assembly 14 affixed to a rear side 10 of the container portion 12. The container portion 12 is comprised of a main pouch 16 to which the handle frame assembly 14 is secured by two rectangular bars 18 and a series of threaded fasteners 20. As can be appreciated, other forms of fasteners, such as rivets, can be used to secure the handle frame assembly 14 to the pouch 16. Additionally, depending on the materials from which the pouch 16 and assembly 14 are made, the assembly 14 can be secured to the pouch, by welding, gluing, or other conventional means. The main pouch 16, when viewed from above, presents a rounded perimeter, which assists in positioning and transporting the golf bag in a driving golf cart during play. The main pouch, although shown to be generally oval, can be circular or any other desired shape. Four clasps 22 are affixed to the rear side of the main pouch 16 adjacent to handle frame assembly 14. A lower side pouch 24 and upper side pouch 26 are attached to one side of the main pouch 16. The lower side pouch 24 includes a top 28 and body portion 30, which can be joined or separated by means of a zipper 32. Similarly, the upper side pouch 26 is comprised of a top 34, body portion 36, and zipper 32. The main pouch 16 is tubular in shape and is fabricated with an upper portion 38 and a lower portion 40. An oval lip 42 with zipper 44 and zipper head with clasp 46a attached thereon is affixed to the upper portion 38 of the main pouch 16 and encloses an aperture 48. An optional top 50 cover with zipper and clasp 46b is aligned over the over lip 42 for releasable attachment thereon.

As is common, dividers (not shown), in the form of spaced apart bars, or in the form of a grid, is preferably placed within the main compartment or pouch 16. Often, the dividers are positioned near the pouch top portion 38. However, preferably, the dividers are spaced below the pouch top portion. By positioning the dividers below the top portion, for example, approximately one-third of the way down from the top portion, it is easier for a golfer to place golf clubs in the pouch.

A pair of wheels 52 is attached by means of an axle 54 and fastener brackets 56 to the lower, rear corner of the main pouch 16. The bottom side or floor of the main pouch 16 makes contact with the ground surface at the front corner thereof and tapers upwardly toward the rear corner so that the rearward portion of the bottom side or floor is raised above the ground surface for some distance and is supported as such by the wheels 52 and axle 54. When the golf bag 10 is tilted back upon the wheels 52 and axle 54, the bag 10 is thus raised above the ground surface and therefore easily transported by the wheels 52.

Referring again to FIG. 1, the handle frame assembly 14 is fabricated of a retractable and extendable portion 58 and a fixed portion 60, said fixed portion 60 attached directly to the rear side of the main pouch 16 by threaded fasteners 20. Alternatively, the fixed portion 60 can be mounted to the main pouch to be spaced from the main pouch, to space the complete handle frame assembly 14 from the main pouch. The retractable portion 58 of the handle frame assembly 14 is comprised of a horizontal member or hand grip 62 and two vertical members 64 that are attached at one end to opposing ends of the hand grip 62. A button 66 is disposed within the center of the hand grip 62 and engages a locking and release apparatus that will be described later in this disclosure. Similarly, the fixed portion 60 of the handle frame assembly 14 is constructed of two vertical members 68 and a horizontal member 70. The vertical members 64 of the retractable portion 58 are disposed in telescoping engagement within the vertical members 68 of the fixed portion 60 of the handle frame assembly 14 and extend or retract with respect to said vertical members 68 when the hand grip 62 is pulled upward or pushed downward, respectively. Rectangular protuberances 72 anchor vertical members 64 of the retractable portion 58 within the vertical members 68 of the fixed portion 60, thereby preventing the vertical members 64, 68 from becoming disengaged from the vertical members 68.

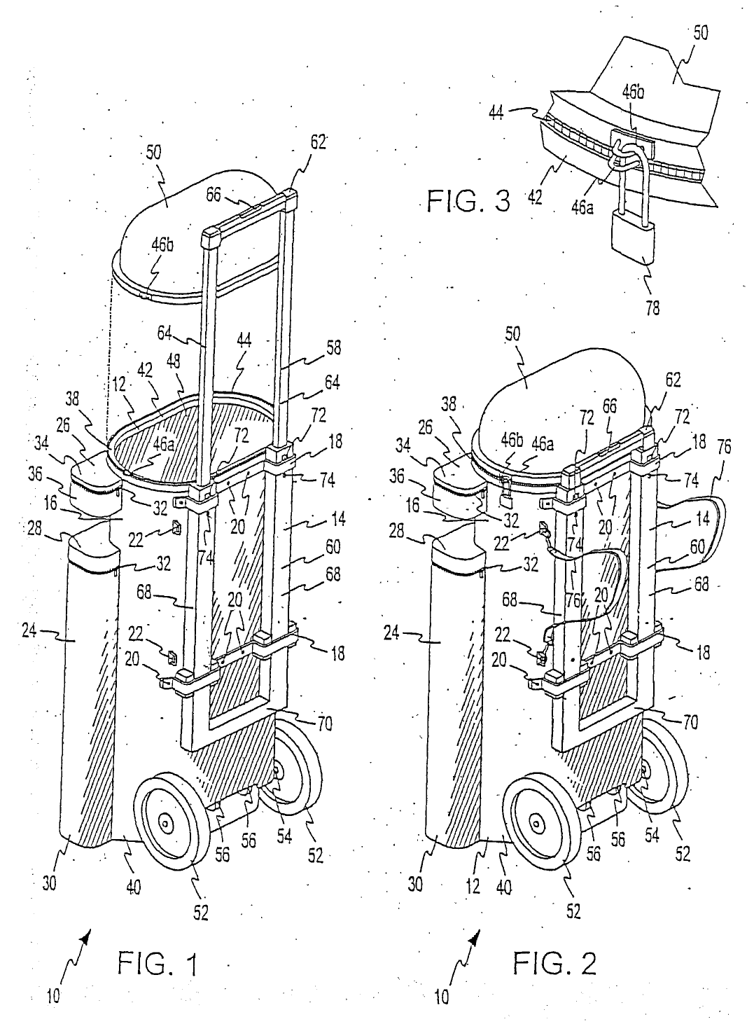

Buttons 74 extend or retract with respect to cooperating apertures in response to actuation of the locking and release mechanism situated within the handle frame assembly 14 in order to lock the retractable portion 58 of the handle frame 14 in an extended or upright position during use as shown in FIG. 1 or to release the retractable portion 58 of the handle frame assembly 14 from the extended position and allow it to assume a retracted position within the fixed portion 60 of the handle frame assembly 14 as illustrated in FIG. 2. Also, a pair of shoulder straps 76 is releasably affixed to the clasps 22 for carrying the golf bag 10 over stair steps when it is infeasible to pull said golf bag 10 upon the wheels 52 over the stair steps.

The top cover 50 is releasably affixed to the oval lip 42 of the main pouch 16 by means of the zipper 44. As shown in detail in FIG. 3, the cover 50 can be secured to the lip 42 and pouch 16 by positioning a lock 78 within the aligned zipper head with clasp 46a and clasp 46b. In an alternate embodiment (not shown), two zippers are attached to the top 50 cover and oval lip 42. Each zipper is fabricated with a dedicated zipper head with clasp. The lock 78 can then pass through the clasp of each zipper head. The top cover 50 and oval lip 42 are securely joined when the zipper heads with clasps receive the lock 78 once the zipper heads with clasps are pulled together as necessary to close the two zippers.

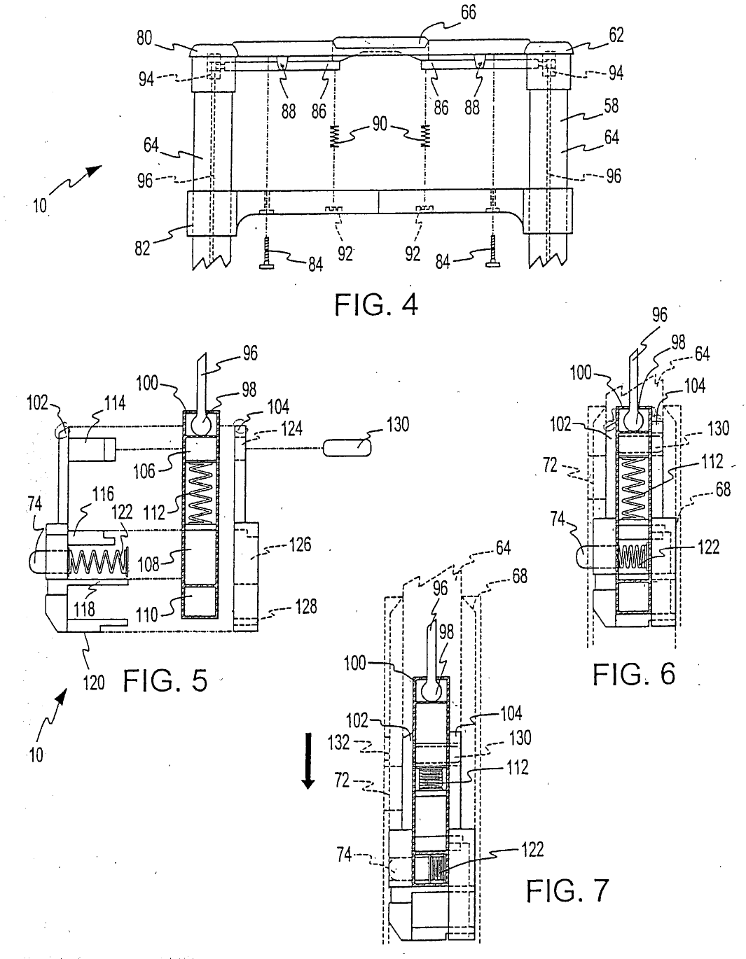

As shown in FIG. 4, the hand grip 62 is comprised of a rectangular upper member 80 and a rectangular lower member 82, which is secured to the upper member 80 by means of threaded fasteners 84. A pair of rods 86 is attached by means of fasteners 88 to the underside of the upper member 80. The ends of the rods 86 that face each other communicate with the underside of the button 66. Springs 90 affixed to the lower member 82 within spring seats 92 urge upward against the ends of the rods 86 to ensure that ends of the rods 86 make continual contact with the button 66. Hangers 94 are attached to opposing ends of the rods 86 and secure elongate rods 96 thereon that are otherwise disposed within the interior of the vertical members 64, 68 of the handle frame assembly 14.

As the rectangular rods 86 are medially attached to respective fasteners 88 in a pivoting configuration, the ends of the rods 86 communicating with the button 66 are urged downward when the button 66 is pushed and the opposing ends thereof are raised upward, thereby lifting the hangers 94 and rods 96 from their initial position. The ends of the rods 86 and 96 that engage each other are hooked to form, a positive engagement. This positive engagement will ensure that the rods 96 will be lifted by the rods 86 when the button 66 is depressed. Alternatively, the rods 86 and 96 could be independently secured to the hanger 94.

In FIGS. 5-7 the distal end of a rod 96 with anchoring knob 98 is illustrated as attached to and controlling operation of a locking and release apparatus that is located within the vertical members 64, 68 of the handle frame assembly 14 near the protuberances 72. As displayed in FIG. 5, the apparatus is comprised of a middle member 100 into which the rod 96 and knob 98 are situated and two side members 102, 104. The middle member 100 is rectangular in shape and is fabricated with an upper bore 106, middle bore 108, lower bore 110, and spring 112. The first side member 102 is partially constructed of an upper projection 114, two middle projections 116, 118, lower projection 120, and spring 122. The second side member 104 contains an upper bore 124, middle bore 126, and lower bore 128. When the members 100, 102, 104 are assembled as shown in FIG. 6, the upper projection 114 of the first side member 102 communicates with the upper bore 106 of the middle member 100 and upper bore 124 of the second side member 104; the first middle projection 116 communicates with the middle bores 108, 126; and the second middle member 118 communicates with the lower bore 110 of the middle member 100 and middle bore 126 of the second side member 104. The lower projection 120 of the first side member 102 is received directly by the lower bore 128 of the second side member 104. Additionally, a pin 130 extends through the upper bore 124 of the second side member and into the upper bore 106 of the middle member 100. As can be appreciated, there are openings (not shown) in the side surfaces of the bores of the middle member 100 to allow the projections of the first side member 102 to pass through the middle member bores to be received by the second side member bores. In this configuration, the spring 112 of the middle member 100 is fully extended, and the spring 122 of the first side member 102 is partially compressed, as seen in FIG. 6. In response to urging of the spring 122 of the first side member 102, the button 74 extends through a cooperating aperture 132 (FIG. 7) formed within the vertical member 68 of the fixed portion 60 of the handle frame assembly 14, thereby preventing the vertical member 64 of the retractable portion 58 from dropping into the vertical member 68 of the fixed portion 60 as necessary when the retractable portion 58 of the handle frame assembly 14 is fully extended with respect to the fixed portion 60.

As shown in FIG. 7, when the button 66 is pushed downward, the rod 96 and middle member 100 are pulled upward with respect to the vertical members 64, 68. Such action compresses the spring 112 of the middle member 100 and allows the spring 122 of the first side member 102 to extend, thereby pulling the button 74 inward past communicating aperture 132. Consequently, the vertical member 64 of the retracting portion 58 of the handle frame can be pushed downward with respect to the vertical member 68 of the fixed portion 60 of the handle frame until handle frame assembly 14 assumes the collapsed or stowed configuration.

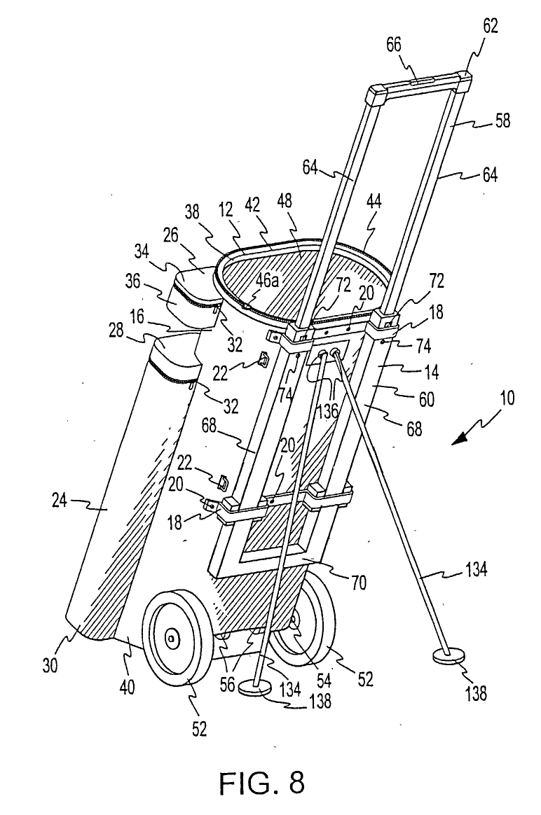

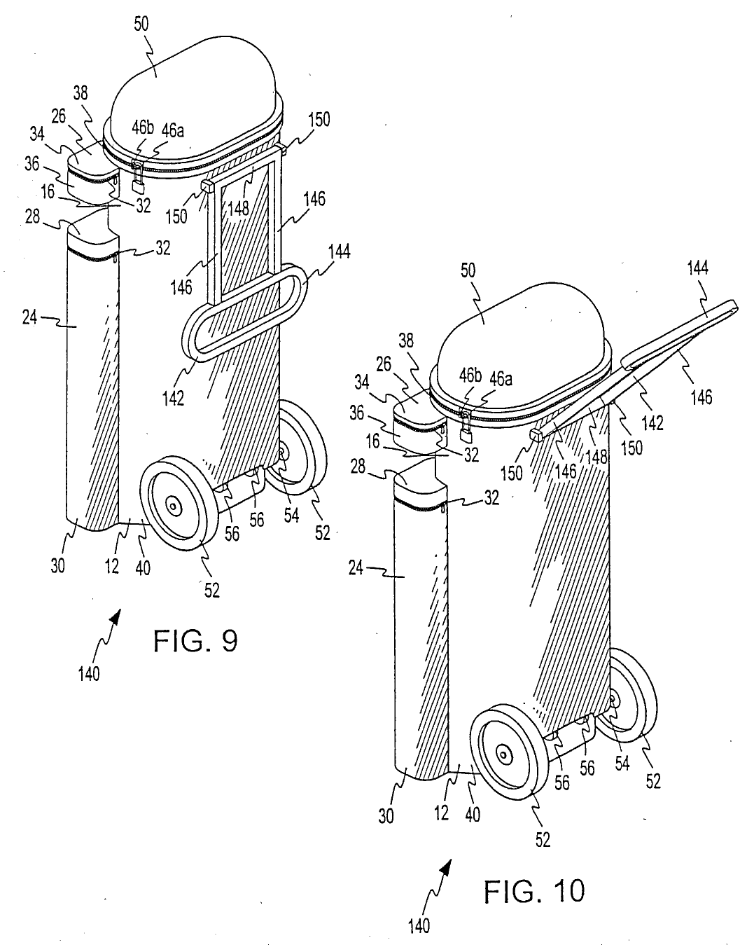

An optional means of supporting the golf bag 10 albeit at an inclined or tilted position is illustrated in FIG. 8. A support stand 134 comprising two elongate rods is attached by means of a fastener 136 with pivoting sockets to the upper rear side of the main pouch 16. Circular foot 138 members are affixed to the ends of the rods opposite to the ends attached to the fastener 136 and assist in stabilizing the support stand 134 upon the ground surface.

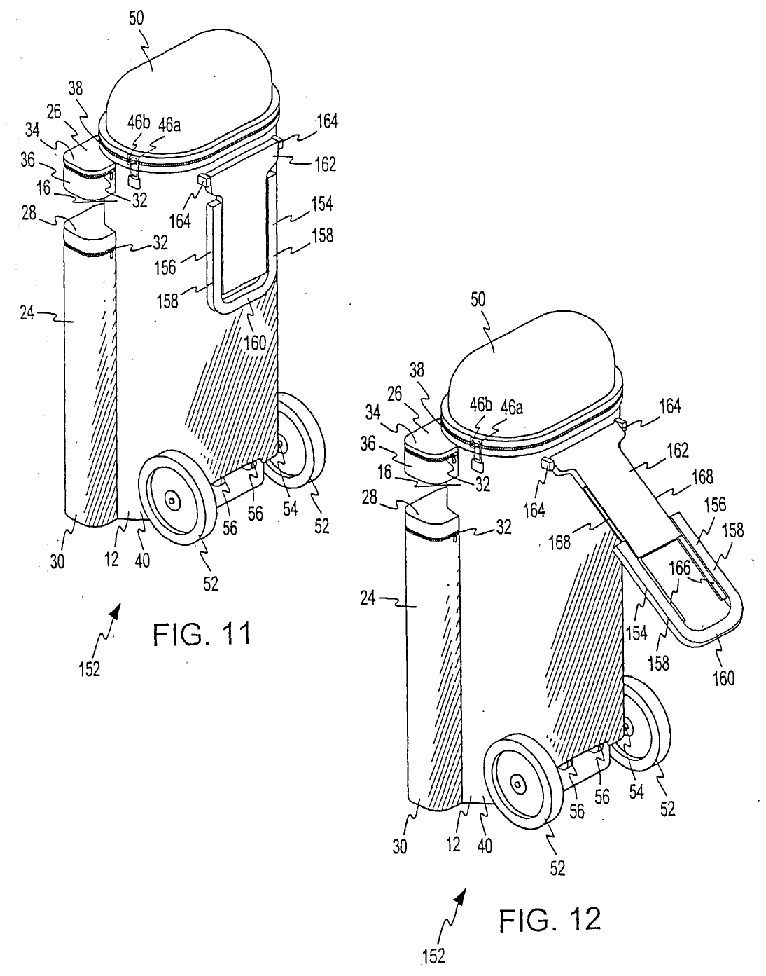

In FIG. 9, a second embodiment 140 of the transportable golf bag 5 is illustrated with a handle 142 attached to the rear side of the main pouch 16. The handle- 142 is comprised of an oval hand grip 144, two arm members 146, and a connecting member 148. The arm members 146 are attached at a first end to one side of the hand grip 144 and extend in parallel relation therefrom and are attached at a second end to the connecting member 148. The connecting member 148 is pivotally attached to protrusions 150 on opposing sides thereof. As such, the handle 142, as shown in FIG. 10, can be pivoted upon the connecting member 148 and protrusions 150 to a raised position and locked into place at an appropriate angle with respect to the main pouch 16 for pulling the golf bag 140. Preferably, the fit between the protrusions 150 and the connecting member 148 or the ends of the arms 146 is sufficiently tight so that the handle 142 will not pivot freely relative to the protrusions 150 and the main pouch 16. That is, some effort (albeit a slight effort) is required to move the handle 142 between is raised and lowered positions shown in FIGS. 10 and 9, respectively. This frictional fit will also enable the handle 142 to remain raised, when raised. Alternatively, a locking mechanism, such as a spring biased ball in the ends of the arms which would be received in a series of discrete indentations arranged in an arc on the inner surface of the protrusions 150 can be used to more positively hold the handle 142 in a desired position relative to the pouch 16.

A third embodiment 152 of the transportable golf bag is illustrated in FIG. 11 with an extendible/retractable handle 154 attached to the rear side of the main pouch 16. The handle 154 is comprised of a hand grip 156 having two arm members 158 disposed in parallel relation and attached at first ends thereof to a connecting member 160, and additionally comprised of a flat panel member 162, which is pivotally attached to protrusions 164. Referring to FIG. 12, the extendible/retractable handle 154 can be pivoted upon the panel member 162 and the protrusions 164 to a raised position and eventually locked into place at an appropriate angle with respect to the main pouch 16. The hand grip 156 is slidably engaged to the panel member 162 with flanges 166 located on facing sides of the arm members 158, said flanges 166 disposed within slots 168 situated on opposing sides of the panel member 162. As such, the hand grip 156 can be extended or retracted with respect to the panel member 162 to facilitate pulling the golf bag 152.

While this version of the invention has been illustrated and described in detail in the drawings and foregoing description, the same is to be considered as illustrative and not restrictive in character, it being understood that only the preferred embodiments have been shown and described and that all changes and modifications that come within the spirit of the version of the invention are desired to be protected. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

From the foregoing, it will be understood by persons skilled in the art that an improved, transportable golf bag with retractable handle has been provided. The invention is relatively simple and easy to manufacture, yet affords a variety of uses. While our description contains many specificities, these should not be construed as limitations on the scope of the version of the invention, but rather as an exemplification of the preferred embodiments thereof. The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred forms have been made only by way of example and numerous changes in the details of construction and combination and arrangement of parts may be resorted to without departing from the spirit and scope of the invention.

1. A transportable golf bag comprising a main pouch, sized to receive golf clubs, wheels at a bottom of said golf bag, said wheels being sized, shaped, and positioned to allow for said golf bag to be rolled over a surface; and a handle assembly; said handle assembly comprising:
a fixed portion, said fixed portion comprising at least one hollow member mounted to said main pouch; said hollow member including a notch therein; and
a moveable portion selectively moveable between a raised and lowered position relative to said fixed portion and comprising a vertical member sized to telescopingly engage said fixed portion hollow member to be movable relative to said fixed portion hollow member;
a rod received within said moveable portion vertical member and extending from said vertical member portion into said fixed portion hollow member; said rod being moveable axially in said vertical member portion;
a button assembly on said moveable portion, said button assembly comprising a button and being operatively connected to said rod to move said rod within said moveable portion vertical member when said button assembly button is pressed;
a locking assembly connected to a bottom of said rod; said locking member comprising a spring biased button; said locking assembly being moveable between a first position in which said locking assembly button engages said notch of said fixed portion hollow member to lock said movable member in its raised position, and a second position in which said locking assembly button is disengaged from said notch to enable said moveable member to be moved to its lowered position; said locking assembly being moved between its first and second position by movement of said rod.

2. The transportable golf bag of claim 1 wherein said locking assembly comprise a frame, a first vertically oriented spring in said frame, and a second generally horizontally oriented spring in said frame; said second spring biasing said locking assembly button outwardly; wherein, when said locking assembly is in its said first position, said first and second springs are compressed and in its said second position said first and second springs are extended.

3. The transportable golf bag of claim 1 wherein said moveable member comprises a horizontal cross-bar defining a handle; said button assembly being mounted in said cross-bar and comprising a lever having a first end operatively connected to said button assembly button and a second end operatively connected to said rod; said lever being pivotally mounted in said cross-bar between said first and second ends; whereby, when said button assembly button is pressed, said first end of said lever is lowered and said second end of said lever, and hence said rod, are raised.

4. The transportable golf bag of claim 3 wherein said button assembly comprises a spring member which biases said lever first end upwardly;

5. The transportable golf bag of claim 4 wherein said cross-bar comprises an upper member and a lower member; said lever being mounted between said cross-bar upper and lower members; said spring member being positioned between said lever first end and said cross-bar lower member.

6. The transportable golf bag of claim 1 wherein said golf bag includes a bottom; said bottom including a front portion and rear portion; said rear portion sloping upwardly from said front portion, such that, when golf bag is placed on a surface, a back edge of said rear portion is spaced vertically from said surface; said wheels being mounted to said golf bag near said rear portion back edge such that when said golf bag is resting on said bottom front portion, said wheels are raised above said surface.

7. A transportable golf bag comprising a bottom and side walls defining a pouch sized to receive golf clubs;
said bottom having including a front portion and rear portion; said rear portion sloping upwardly from said front portion, such that, when golf bag is placed on a surface, a back edge of said rear portion is spaced vertically from said surface;
wheels mounted to said golf bag near said rear portion back edge such that when said golf bag is resting on said bottom front portion, said wheels are raised above said surface; and
an extendable retractable handle assembly mounted to said golf bag side wall.

8. The golf bag of claim 7 wherein said handle assembly comprises:
a fixed portion, said fixed portion comprising at least one hollow member mounted to said golf bag wall; said hollow member including a notch therein; and
a moveable portion selectively moveable between a raised and lowered position relative to said fixed portion and comprising a vertical member sized to telescopingly engage said fixed portion hollow member to be movable relative to said fixed portion hollow member;
a rod received within said moveable portion vertical member and extending from said vertical member portion into said fixed portion hollow member; said rod being moveable axially in said vertical member portion;
a button assembly on said moveable portion, said button assembly comprising a button and being operatively connected to said rod to move said rod within said moveable portion vertical member when said button assembly button is pressed; and
a locking assembly connected to a bottom of said rod; said locking member comprising a spring biased button; said locking assembly being moveable between a first position in which said locking assembly button engages said notch of said fixed portion hollow member to lock said movable member in its raised position, and a second position in which said locking assembly button is disengaged from said notch to enable said moveable member to be moved to its lowered position; said locking assembly being moved between its first and second position by movement of said rod.
